(19) United States
(12) Patent Application Publication
(10) Pub. No.: US 2007/0143010 A1
(43) Pub. Date: Jun. 21, 2007

(54) Physical navigation button surrounded by a display

(76) Inventor: Henrik Jensfelt, Limhamn (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/312,211

(22) Filed: Dec. 20, 2005

(51) Int. Cl. G01C 21/32

(52) U.S. Cl. 701/208

(57) ABSTRACT

An electronic equipment is provided that joins or merges display and navigation features of an interactive device.

### TECHNICAL FIELD OF THE INVENTION

The present invention relates generally to the field of electronic equipment with displays and navigation devices, and, more particularly, to joining or merging of a display and a navigation device. The invention also relates to a physical navigation button surrounded by a display.

### DESCRIPTION OF RELATED ART

The main navigation input device for electronic equipment that include displays has been placed outside the area of the display (also referred to as display-unit). This placement limits the possibilities to assign input icons all around the navigation device on the actual display. This placement requires substantial concentration by a user, who has to look at both the display and the navigation device, which may not be in the same field of view of the user. Examples of such electronic equipment include hand held computers, personal digital assistants (PDAs), electronic games, electronic communication devices, e.g., mobile telephones, etc.

Modern mobile phones typically have a display, a keyboard, and a navigation device. The display has a viewing area that may be viewed by a user and may present various information, such as, for example, names and telephone numbers, residence and/or email addresses, date and/or timer information, calendar information, etc. Some mobile phones also can present pictures or other images on the display, and some mobile phones are able to present on the display icons, e.g., a graphical interface, which may be selected to initiate a given function, e.g., calendar, camera, text or other messaging and/or other functions. Various types of displays are available, e.g., liquid crystal display (LCD), organic light emitting diode display (OLED), etc. The keyboard (sometimes referred to as a keypad) includes several dialing keys (sometimes referred to as buttons or switches), one or more keys to initiate a phone call, to send a text message, to answer an incoming phone call, etc. The keyboard also may include one or more soft keys (sometimes referred to as function keys) that can be operated to carry out functions, such as a function that is shown on the display, e.g., to scroll through the displayed names and telephone numbers, to scroll through one or more functions, e.g., that are represented by words or respective icons, shown on the display, to select a given name/telephone number, function or the like. A navigation device may be used to point to respective icons shown on the display, to scroll through a list of names and phone numbers shown on the display, etc. An exemplary navigation device is a rocker switch that may be pressed manually to rock upward, downward, left or right (or at some other angle) to close a respective switch to select respective icons that are shown on the display, to effect the mentioned scrolling, etc. The rocker switch may include a selection button or key, e.g., at the center or elsewhere, that may be pressed to produce a selection signal to select a given name, function, telephone number, etc., that is being pointed to based on the operation of the rocker switch.

When navigating about the display of electronic equipment, for example, of a type mentioned above or some other type, the user typically watches both the display and at the navigation device while operating the navigation device to point, to scroll, etc., and the user may operate the selection button, soft key, etc., to dial a phone number, to carry out a desired function, etc. It is possible to make a mistake because the display and the navigation device are separated from each other, e.g., usually the navigation device is at the bottom or side of the display.

The displays of such electronic equipment that present icons to represent functions usually are relatively fixed, e.g., they do not change very much or are not changed at all; and this characteristic facilitates using a conventional navigation device, even though it is somewhat remote from the display, because a user would know where to expect to see a given icon on the display to be selected by operating the navigation device. The versatility of such displays, therefore, is somewhat limited due to the limited number of icons or other graphic images or listed information that can be shown on the display. Also, it is inconvenient, sometimes even difficult, for the user to coordinate visually and manually between a navigation device and the different icons, etc.

Limitations on the number of icons or other displayed features on the display of such devices and corresponding limitations on conveniently available functions of such electronic equipment and/or the difficulty in coordinating a navigation device with a complex or changing display limit the versatility of such electronic equipment. Language limitations also restrict use of prior electronic equipment to only a relatively small number of languages—it is inconvenient to increase the number of languages used in such electronic equipment.

There is a need to facilitate coordination of displays and navigation devices.

There also is a need to increase, to enhance, and/or to improve the versatility of displays with interactive devices, such as navigation devices, and/or other parts of mobile phones, hand held computers, games, etc.

### SUMMARY OF THE INVENTION

Briefly, an aspect of the present invention joins or merges display and navigation features of an interactive device, such as, for example, for electronic equipment or other device that has, uses or may use a display and a navigation device.

An aspect of the invention relates to electronic equipment, comprising a display and a navigation device, the display and navigation device merged such that the navigation device physically is within viewable area of the display.

According to another aspect, the electronic equipment includes a mobile phone, including transmitter, receiver, and logic and control circuitry.

In accordance with another aspect, the electronic equipment includes a hand held electronic device.

According to yet another aspect, the display has a viewable area, and the navigation device is within that viewable area.

According to still another aspect, the navigation device includes a stick-like device.

In accordance with another aspect, the display includes a touch sensitive display.

According to still another aspect, the electronic equipment further includes control and logic circuitry responsive to operation of the navigation device to operate the display to show an indication that an area of the display to which the navigation device is pointing, and a selector providing input to the control and logic circuitry to carry out a function with regard to the area to which the navigation device is pointing.

In still another aspect, the electronic equipment includes adhesive attaching the stick-like device relative to the display.

According to another aspect, an opening through which the navigation device is mounted relative to the display.

According to yet another aspect, the opening is through the display and the navigation device extends through the opening.

In accordance with another aspect, the electronic equipment includes a support holding the navigation device over the front of the display.

In yet another aspect, the electronic equipment includes a transducer responsive to positional orientation of the navigation device to provide signals representing such orientation.

Still another aspect relates to the display including a touch sensitive display, and the transducer comprising a portion of the touch sensitive display.

According to another aspect, the display includes a touch sensitive display, and the navigation device includes a virtual display shown by the touch sensitive display.

Another aspect of the invention relates to a method of using electronic equipment. The method includes the steps of operating a navigation device located within viewable area of a display of the electronic equipment to point to a selection that is shown on the display.

According to yet another aspect, the method includes acting on the selection.

In accordance with another aspect, the method includes changing the image shown on the display and coordinating operating of the navigation device with respect the shown image.

In yet another aspect, the step of acting includes pressing a key.

In accordance with still another aspect, the step of acting includes pressing the navigation device.

According to another aspect, the step of operating includes moving a joy stick that is mounted on or through the display.

In yet another aspect, the step of operating includes moving a trackball that is mounted on or through the display.

In accordance with still another aspect, the step of operating includes operating a touch pad.

According to another aspect, the step of operating includes pressing a touch sensitive display.

According to still another aspect, the step of operating a navigation device and acting on the selection includes changing the functions of the electronic equipment in coordination with the image shown on the display.

According to yet another aspect, the step of operating a navigation device and acting on the selection includes changing the language of functions shown on the display.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views. Also, parts designated by primed reference numerals may be similar in form and/or function to parts designated by the same unprimed reference numeral.

FIG. 1 is a perspective view of electronic equipment, e.g., a mobile phone, with a display and navigation device merged as a unit;

FIG. 2 is a perspective view of another type of mobile phone with a display and navigation device merged as a unit;

FIG. 3A is a schematic isometric view of electronic equipment, e.g., a hand held computer, personal digital assistant, electronic game, or the like, having a display and navigation device merged as a unit;

FIG. 3B is a schematic block diagram showing steps that may be used to carry out an exemplary operation of the electronic equipment;

FIG. 4 is a schematic illustration showing a navigation device attached to the front of a display;

FIG. 5 is a schematic illustration of a navigation device mounted through a display as a merged display and navigation device;

FIG. 6 is a schematic isometric view similar to FIG. 3, illustrating a strip bridge mounting for a navigation device merged with a display;

FIG. 7 is a fragmentary elevation view showing the mounting of FIG. 6;

FIG. 8 is a schematic isometric view similar to FIG. 3, illustrating a crossed bridge mounting for a navigation device merged with a display;

FIG. 9A is a schematic block diagram illustrating electronic equipment having a display and navigation device merged as a unit;

FIG. 9B is a schematic block diagram illustrating electronic equipment for use as a mobile phone or the like;

FIG. 10 is a schematic illustration of a merged display and navigation device presenting functions of a mobile phone;

FIG. 11 is a schematic illustration of a merged display and navigation device presenting a number of functions shown in the English language;

FIGS. 12A and 12B are schematic illustrations of a merged display and navigation device presenting a number of functions shown in the Spanish and Swedish languages, respectively;

FIGS. 13 and 14 are schematic illustrations similar to FIG. 3 with images of scenes 1 and 2 of a game shown on the display;

FIG. 15 is a schematic plan view of electronic equipment having a display and a virtual navigation device merged as a unit;

FIG. 16 is a schematic illustration similar to FIG. 15 using a track ball as the navigation device;

FIG. 17 is a schematic illustration similar to FIG. 15 using a touch pad as the navigation device; and

FIG. 18 is a schematic illustration similar to FIG. 15 using a off-center navigation device.

### DETAILED DESCRIPTION OF EMBODIMENTS

The term electronic equipment includes portable radio communication equipment. The term portable radio communication equipment, which hereinafter is referred to as a mobile radio terminal, includes equipment such as mobile telephones, communicators, i.e., electronic organizers, hand held computers, personal digital assistants (PDAs), smart phones or the like. The term electronic equipment also includes electronic games and other devices in which a display and a navigation device are employed during use. The term electronic equipment also includes electronic organizers, hand held computers, personal digital assistants (PDAs), games and other devices with or without telephone or similar type of communication capability.

An example of the present invention is described herein in the context of a mobile terminal in the form of a mobile telephone, but it should be understood that the mobile terminal of the present invention is not so limited and may find utility in other applications. For example, the term mobile terminal as used here may include a Personal Communications System (PCS) terminal that may combine a mobile telephone with data processing, facsimile and data communications capabilities; a Personal Digital Assistant (PDA) that can include a radiotelephone, pager, Internet/intranet access, Web browser, organizer, calendar and/or a global positioning system (GPS) receiver; a conventional laptop and/or palmtop receiver or other computer system that includes a receiver for generating different levels of sound. Mobile terminals may also be referred to as pervasive computing devices; and electronic gaming; etc. In one embodiment of the present invention, the invention may be implemented on a computer system having a memory circuit for storage of data, a receiver which acts to generate different levels of sound, and a control circuit that is configured to control the flow of data between the memory and receiver. An example of the invention also is described in the context of a game, hand held computer, PDA, etc., that may or not have telephone type communication capability.

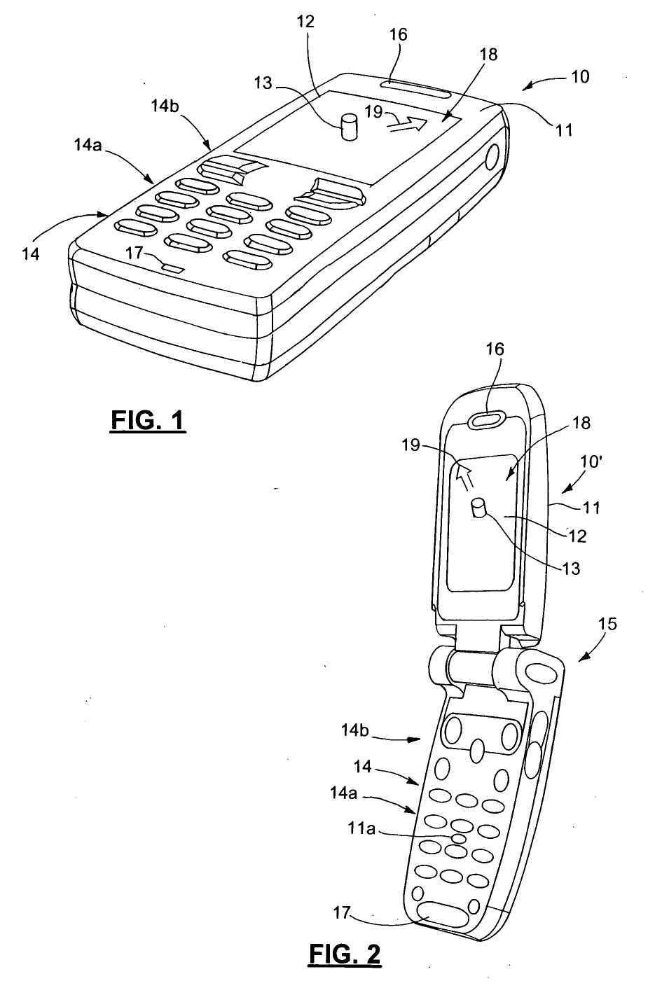

Referring to FIGS. 1 and 2 schematic illustrations of electronic equipment in the form of mobile telephones, for example, are illustrated, respectively, at 10, 10′. Each mobile telephone 10, 10′ includes a housing 11, a display 12, which is mounted in, supported by, etc., the housing, a navigation device 13, and a number of keys (sometimes referred to as buttons, switches or the like) 14. The keys 14 include a dialing keypad or dialing keys, for example, including the numbers 0 through 9, the asterisk, and the pound sign, generally indicated at 14a. The keys 14 also may include one or more soft keys, sometimes referred to as function keys, which may be pressed or otherwise operated, for example, to initiate a telephone call, to answer a telephone call, to end a telephone call, to select information, e.g., a name and telephone number, shown on the display, etc. The mobile telephone 10′ includes a hinge 15 by which two parts of the housing 11 are connected mechanically to allow the parts to be unfolded or flipped open for use and folded closed for storage. The mobile telephones 10, 10′ include a speaker 16 to present sounds to the user, e.g., ringing, voice, game tones, etc.; and a microphone 17 to pick up sounds, e.g., voice or other ambient sounds, for example, to be communicated to another telephone, for storage, for the like.

The navigation device 13 is physically within viewable area 18 of the display 12. The viewable area 18 is the part of the display 12 on which information, icons, or other images, etc., may be shown for viewing or to be seen by a user of the electronic equipment. In the illustrated embodiments of the several figures hereof, the navigation device 13 is surrounded by the display 12. By making a physical opening in the display to locate the navigation device there or to provide another mechanism, e.g., as is described in several embodiments, to allow the navigation device to be within the display area, the navigation interface can be simplified. The input choices around the navigation device can be changed, updated, etc. to fit the menus of the electronic equipment and to provide for a one-key-interface (one click to initiate an action, function or the like) for the electronic equipment employing the invention.

In several embodiments illustrated the navigation device 13 is located approximately at a center area of the display 13, and in another exemplary embodiment the navigation device is offset away from center of the display, but still is within viewable area 18 of the display. The navigation device 13 is illustrated in several embodiments in the shape or form of a joy stick, for example, such as a joy stick of the type that is conventionally used as a pointing device in portable computers, e.g., as the joy stick that is mounted in the midst of the keyboard of a Dell computer, model Latitude, D600. In several of the illustrations of the present application the joy stick type navigation device 13 is shown protruding to a relatively large extent above the surface of the display 12; these illustrations are schematic and are used to emphasize the navigation device. However, it will be appreciated that the navigation device may be of a smaller height or even a larger height, as may be desired, or may be of some size and/or shape other than as illustrated in the drawings.

The navigation device 13 may be used to move a pointing device, such as, for example, an arrow-shape cursor 19, that is presented (shown) on the display 12. By manually manipulating the navigation device 13, e.g., by pushing, pressing, urging, bending, etc., in a given direction, the position of the cursor, as shown on the display 12, may be changed in a manner similar to the operation of a cursor and joy stick pointing device of a conventional lap top computer. By positioning the cursor 19 at or pointing to a given icon or location on the display 12, a function, operation, etc., of the electronic equipment may be initiated automatically or in response to providing an appropriate selection signal. Associated with the navigation device 13 is a suitable transducer (not shown in FIGS. 1 and 2) to sense the direction or position information representing the direction that the navigation device 13 is urged by a user thereby to provide suitable signals for operating the cursor. The transducer associated with the navigation device 13 also may be responsive to a pressing action, e.g., pressing down, of the navigation device to provide a selection signal. Thus, the selection signal may be provided by pressing a function key 14b and/or by pressing the navigation device 13. Circuitry for carrying out functions in the electronic equipment may be similar to that used in computers that use a mouse to move a cursor to point to a location shown on a display and the mouse click button, e.g., the “left click” button or switch, to carry out the function pointed to by the cursor; this is exemplary only, and it will be appreciated that other circuitry that is appropriately constituted, connected, programmed, etc., may be used.

The positioning of the navigation device 13 in the viewable area 18 of the display 12 facilitates coordinating operation of the navigation device with images, icons, information, and the like that is shown on the display. Operation of the navigation device 13 in coordinated relation with the displayed images, etc., may be more intuitive and easy to comprehend compared to electronic equipment in which the navigation device is separated from the viewable area of the display and, thus, out of the field of view of the user.

The mobile telephone 10′ may include an opening or recess 11a that is aligned with the navigation device 13 when the mobile telephone is flipped closed. The recess 11a is of a suitable size and position to receive a protruding portion of the navigation device when the mobile telephone 10′ is in the closed storage condition.

The mobile telephones 10, 10′ illustrated in FIGS. 1 and 2 may be used in the conventional way to place telephone calls, to answer telephone calls, to carry out text messaging, etc. using the keys 14 and relying on information shown in the display 12. The mobile telephones 10, 10′ also may have additional functionality whereby the navigation device 13 is able to point to various parts of the display 12 to identify or to point to respective icons, names/telephone numbers, etc.; and that which is pointed to may be operated on or carried out by providing a selection signal. Moreover, by operating the navigation device 13, e.g., to move cursor 19 to point to respective icons or representations of functions shown on the display 12, the information shown on the display can be changed, as is described in further detail below, thereby, providing additional functionality for the mobile telephones 10, 10′.

The display 12 may be a liquid crystal display (LCD), light emitting diode (LED) display, organic LED display, or another type of display. The display may be operated by circuitry of the electronic equipment to present (to show) respective images. The display 12 may be a touch sensitive display or may be touch sensitive at one or more respective areas of the display to provide a signal in response to being touched or pressed by a finger, a stylus, etc.

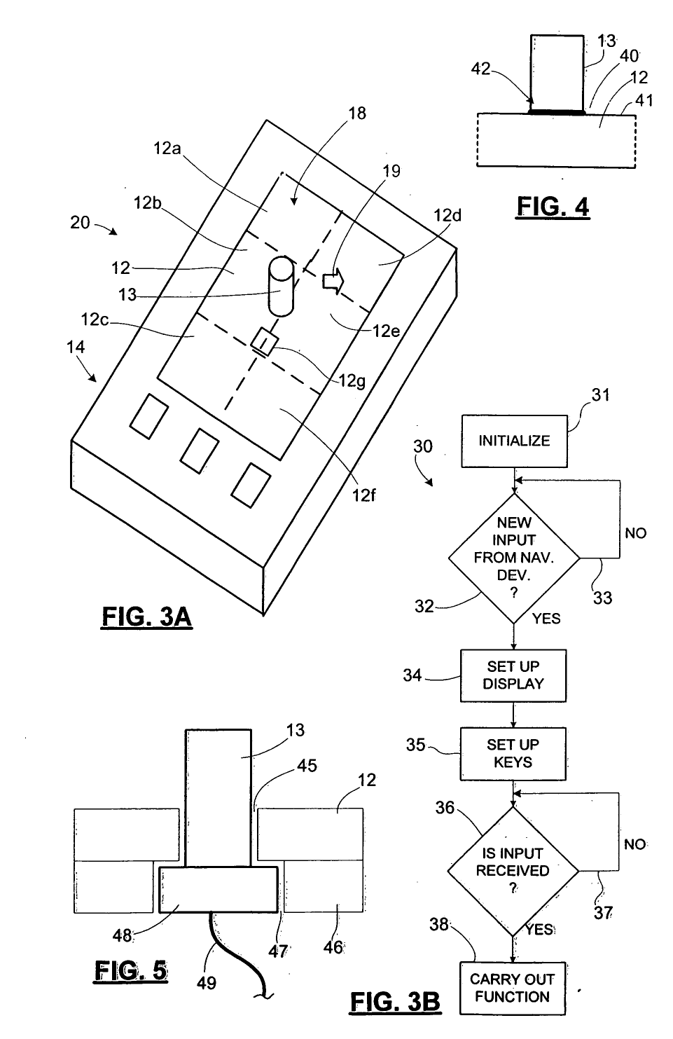

Referring to FIG. 3A, a schematic illustration of another example of electronic equipment 20, such as a hand held computer, PDA, game, music storage and playback device, etc. is illustrated. The electronic equipment includes a display 12, a navigation device 13, and a number of keys 14.

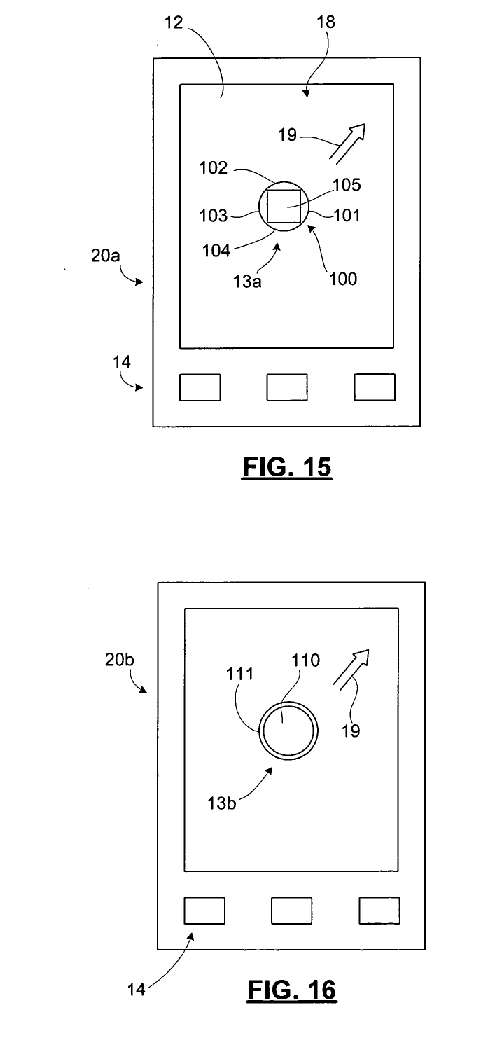

The display 12 and navigation device 13 in the several embodiments may be substantially the same unless otherwise specified, e.g., as with respect to FIGS. 15-18, which are described below. Although three keys 14 are illustrated in the electronic equipment 20, there may be more or fewer keys, depending upon the nature of the product, e.g., for a personal digital assistant, there may be more keys, such as a qwerty keyboard, and for a mobile telephone there also may be a dialing keypad, etc. The keys 14 may include relatively few keys for a game, as games often are played using only the user's left and right thumb digits. The keys 14 may include a power on/off key, a function select key to provide a selection signal, a change screen (and available function(s)) key, and/or keys for various other purposes.

As is illustrated in FIG. 3A, the display 12 is divided in six segments 12a-12f. In operation each of those segments may include a respective icon, for example, such as an icon representing a respective game or a skill level of play for the game, etc.; therefore, in such arrangement the electronic equipment 20 may be used to provide at least six different games or skill levels for playing by a user. By manipulating the navigation device 13, the cursor 19 may be moved to point to a respective segment. While the cursor is pointing to a given segment of the display, a selection signal may be provided by operating one of the keys 14 or by pressing on the cursor 13, etc., to bring up the respective game or skill level corresponding to that segment. The user then may play the game, for example, using the keys 14 and/or the navigation device 13. The segments 12a-12f also may represent other functions, as is described further below.

A segment or area of the display 12g may represent a “change display” function. By pointing to the change display segment and providing a suitable selection signal, the information shown on the display may be changed to present another screen or collection of images representing another set of functions, games, etc. Such change also or alternatively may be achieved by operating one or more of the keys 14. The change display segment may be one of the segments 12a-12f. As the different screens are shown, the navigation device may be operated to point to the respective icons, functions, information, etc., presented on the display.

The navigation device 13 may be operated to point to a location on the display 12, e.g., by moving cursor 19 to designate a location, and a selection signal may be provided by any of various means to select information, to carry out functions, etc., that are represented at that location on the display. Selection may be carried out by pressing a key 14, pressing the navigation device 13, otherwise manipulating the navigation device 13, pointing to a display location for more than a minimum period of time, etc. The images shown on the display may be changed to provide a number of different icons, functions, groups of information, game scenes, etc.

Turning to FIG. 3B, a block diagram 30, which represents and example of a method or process carried out in operation of the electronic equipment 20 is illustrated. The block diagram 30 also represents an example of a method or process of operation of the mobile telephones 10, 10′ described above and of the several other examples of the invention that are described herein. The steps illustrated in the block diagram 30 may be carried out using computer program, software or code that may be prepared by a person having ordinary skill in the art. At block 31 electronics of the electronic equipment 20 are initialized. For example, this may be carried out upon turning on a power switch, pressing a reset button, etc. At block 32 an inquiry is made to determine whether a new input from the navigation device 13 has been received. If not, then a loop line 33 is followed until a new input is received. When such new input is received from the navigation device, then at block 34 the display 12 is set up, and at block 35 the keys 14 are set up. Such set up functions may include, for example, presenting a starting group of images, list of information, etc. on the display 12 and coordinating the keys 14 so that upon pressing a respective key when the navigation device 13 is pointing to respective information, icon, etc., the appropriate function can be carried out. At block 36 an inquiry is made whether an input has been received, e.g., a selection signal or some other input that would cause the electronic equipment 20 then to carry out a function. If an input is not been received, then loop line 37 is followed. If an input, e.g., a selection signal, has been received, then at block 38 a function is carried out. The function may be determined, for example, according to the information currently being shown on the display 12, the setup functions of the keys 14, and which key 14 has been pressed, operated, activated, etc., or whether the navigation device 13 has been pressed or even whether a respective part of the display, e.g., if the display is a touch sensitive display, is pressed or touched. The function at block 38 may be to reset the display 12 to display different images than previously were displayed. The function may be to commence playing a game. The function may be to initiate a telephone call, etc. Other functions may be carried out, depending on the nature of the electronic equipment 20, e.g., whether it is or is to be used as a game, a personal digital assistant, a hand held computer, a mobile telephone, or some other device. It will be appreciated that the block diagram 30 and the steps illustrated and described with respect thereto are exemplary. Other steps, methods, procedures, etc., and sequences of them may be used to carry out the functions of the invention.

In FIG. 4 is illustrated schematically an example of attachment between a display 12 and navigation device 13. The attachment is provided by an adhesive material 40. Various adhesives may be used that are suitable to provide secure connection between the display 12 and the navigation device 13. An epoxy material is one example of an adhesive; there are other examples. The adhesive 40 may be applied to the front surface 41 of the display 12 and/or to a surface 42 of the navigation device 13; and the two parts 12, 13 may be pressed together. If the display 12 is a touch sensitive display, then a portion of the display in the area where the navigation device 13 is attached may be designated for providing signals indicative of the operation of the navigation device. For example, as viewed in FIG. 4, different respective signals may be provided by the touch sensitive display 12 in response to urging of the navigation device 13 to the left, to the right, into the plane of the paper, and out of the plane of the paper; and a selection signal may be provided by the touch sensitive display 12 in response to pressing of the navigation device toward the display. If the display 12 is not a touch sensitive display, then another transducer may be used to provide signals representing action of the navigation device 13.

FIG. 5 illustrates another example of mounting or positioning a navigation device 13 with respect to a display 12, e.g., providing the navigation device in the viewable area of the display. In the embodiment illustrated in FIG. 5, the navigation device extends through a hole or opening 45 in the display 12. The display 12 is supported from a base or support structure 46. Within an open area 47 of the base 46 is a transducer 48. The transducer 48 provides signals via connection 49 or by some other means representing the direction that the navigation device 13 is tilled or thrust by a user, e.g., left, right, into the plane of the paper or out of the plane of the paper, as viewed in FIG. 5 and/or in response to pressing the navigation device 13 against the transducer 48, e.g., to provide a selection signal. The transducer 48 may be a conventional transducer, for example, a transducer of the type used in a conventional lap top computer with a joy stick pointing device, or the transducer 48 may be some other type of transducer that provides appropriate output signals to effect pointing, moving of the cursor 19 or to provide a selection signal.

It will be appreciated that the fragmentary illustrations in FIGS. 4 and 5 represent examples of techniques for mounting and positioning a navigation device in the viewable area of a display 12. Other techniques also may be used and are within the spirit and scope of the present invention.

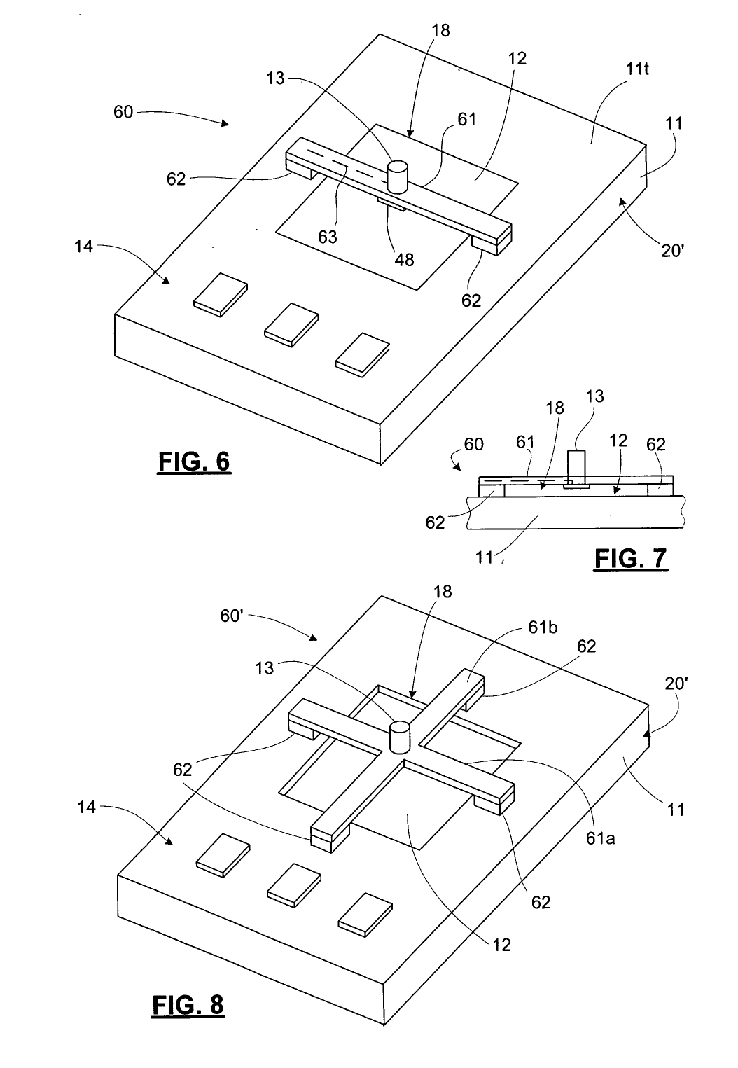

Referring to FIGS. 6, 7, and 8 bridge-type mounting structures 60, 60′ are illustrated. The mounting structures 60, 60′ mount or position a navigation device 13 within the line of sight or viewable area, etc., of a display 12 used in electronic equipment 20′. In FIGS. 6 and 7 the bridge type mounting structure 60 includes a relatively narrow width strip 61 of material that is attached to the housing 11 in a position overlying or above a portion of the viewable area of the display 12. In the embodiment illustrated in FIG. 8 the bridge type mounting structure 60′ includes a pair of strips 61a, 61b that are similar in form and function to this strip 61. The strips 61a, 61b are crossed relative to each other, e.g., being relatively perpendicular or at some other angle; and the navigation device 13 is mounted to the bridge mounting structure 60′ at the area where the strips 61a, 61b intersect. The strips 61a, 61b may be attached to each other where the cross.

Referring to FIGS. 6 and 7, the strip 61 is attached to the housing 11, for example, by adhesive, rivets, screws, detents, or some other mechanism. In the illustration the strip 61 is attached to the top 11t of the housing 11, but the strip may be attached to the sides or to some other part of the housing 11. The strip 61 may be molded as a integral part of the housing 11. The strip 61 may be made of metal, plastic or some other material. In the illustration the strip 61 is attached at the ends by supports 62 at the opposite ends of the strip. The supports are attached to the strip and to the housing 11 using adhesive, rivets, or some other means. The supports 62 space the strip 61 above the viewable area of the display 12 and provides adequate space for slight deflection of the strip 61 and/or positioning of a transducer 48, if used, beneath the strip. The navigation device 13 extends above the strip. An electrical connection 63, e.g., one or more wires, conductive traces, etc., from the navigation device 13 and/or transducer 48 may be provided by, attached to, molded in, etc., the strip 61 to provide navigation signals to circuitry of the electronic equipment 20′ to carry out the functions described elsewhere herein. The electrical connection 63 may pass through one or both supports 62 or may otherwise enter into the housing 11 to provide signals to the circuitry of the electronic equipment.

In operation of the electronic equipment 20′ using the bridge type mounting structure 60, a user may urge, push, etc. the navigation device 13 in a given direction, and that action is sensed by the transducer 48 and is converted to an electrical signal that is coupled via the connection 63 to the circuitry of the electronic equipment 20′. A selection signal may be provided by pressing one or more of the keys 14 and/or by pressing the navigation device 13, as was described above.

In an alternate embodiment a transducer 48 may be located at one or both of the supports 62 and may be electrically coupled to circuitry of the electronic equipment 20′. Urging of the navigation device 13 in a given direction may cause a movement, stress, etc. of the strip 61; and that action may be converted by the transducer(s) to appropriate electrical signals that may be provided to such circuitry of the electronic equipment 20′.

The bridge type mounting structure 60′ shown in FIG. 8 along with the navigation device 13 mounted thereby may function in a manner similar to that described above with respect to FIGS. 6 and 7. If desired, a separate transducer 48 may be provided at each of the supports 62 of the two strips 61a, 61b of the bridge type mounting structure 60′ to provide electrical signals representing operation of the navigation device 13 to the circuitry in the electronic equipment 20′ of FIG. 8.

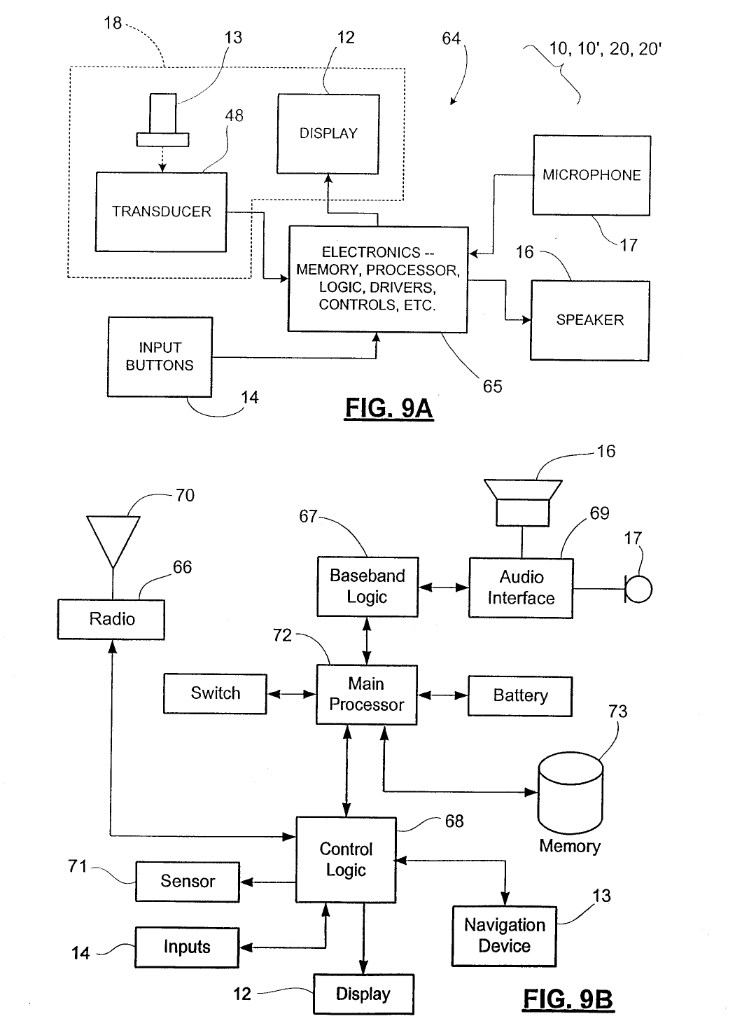

Referring to FIG. 9A, a schematic block diagram of a system 64 illustrating several parts of the electronic equipment 10, 10′, 20, 20′ is shown. Electronics 65, e.g., memory, processor, logic, drivers, controls, etc. may be conventional electronics for such electronic equipment and may be of appropriate type according to the nature of the electronic equipment, e.g., whether it is a mobile telephone, hand held computer, PDA, game, etc. The display 12 is connected to the electronics 65 to receive signals for driving the display to show various images. The navigation device 13 provides input to the transducer 48, which in turn provides electrical input to the electronics to carry out the pointing function described above. Keys 14 provide inputs to the electronics 65. The keys 14 and/or navigation device 13 (with the transducer 48) may provide a selection signal and other signals to operate the electronic equipment. A speaker 16 may receive signals from the electronics 65 to provide an audible output, and a microphone 17 may be coupled to the electronics 65 to provide an input representative of sound. For a personal digital assistant, hand held computer, game, etc., e.g., a device that is not used as a mobile telephone or for some other sound detecting and/or transmitting purpose, the microphone 17 may be omitted. Similarly, an electronic equipment 20, 20′, etc., that does not need to provide an audible output may omit the speaker 16.

In operation of the system 64, inputs are provided the electronics 65, and the electronics provide outputs to present information via the display 12 and sound via the speaker 16. If used in conjunction with a mobile telephone or some other electronic communication device, the electronics 65 also may control the transmitting of signals to a remote terminal, e.g., another mobile telephone, its cellular telephone tower, a satellite, etc.

Referring now to FIG. 9B, an exemplary block diagram of a mobile terminal (mobile telephone type of electronic equipment, e.g., useful in the electronic equipment 10, 10′, 20, 20′, etc. described herein) implementing the present invention is shown. The mobile terminal includes a radio block 66, a baseband logic block 67, a control logic block 68, and an audio interface block 69. The navigation device 13 provides inputs to the control and logic 68 to represent a part of the display to which the navigation device is pointing. Keys or the navigation device itself may be operated, e.g., pressed, thrown, slid, touched, rolled, etc., to cause the pointed to function to be carried out. As the exemplary illustration of FIG. 9B pertains to a mobile phone, the description and illustration of FIG. 9B concerns such a device. However, this description is exemplary only, and similar operation and functions pertaining to other electronic equipment will be appreciated and understood by persons who have ordinary skill in the art.

Within the radio block 66, the receive and transmit information is converted from and to the radio frequencies (RF) of the various carrier types, and filtering using baseband or intermediate frequency circuitry is applied; as is understood in the art. Connected to the radio block 66 is the terminal's antenna system 70 for sending and receiving radio signals between itself and the wireless communication network. In the baseband logic block 67, basic signal processing occurs, e.g., synchronization, channel coding, decoding and burst formatting, as is understood in the art.

The audio interface block 69 handles voice as well as analog-to-digital (A/D) and D/A processing. The audio interface block 69 also receives input through a microphone 17 and produces output through a speaker 16. The speaker 16 can be any of a number of electroacoustic transducer types. According to the present invention, the audio interface block 69 comprises an electronic audio gain circuit for adjusting the audio characteristics of the speaker. In one embodiment, the audio gain circuit includes an audio gain controller which controls a speaker amplifier which amplifies a received audio signal. (Note that amplification as used herein may be either positive or negative.) The audio gain circuit is preferably in the form of programmable gain control circuitry, but may comprise a wide variety of circuits known in the art. Accordingly, a more detailed description of the electronic audio gain circuit is not required.

The control logic block 68 controls and coordinates the functions of the aforementioned blocks and also plays an important role in controlling the human interface components such as display 12, inputs 14″ (representing, for example, Dial and End buttons 83, 84 (FIG. 10)), and a cover position sensor 71. The control logic block may include processing circuitry such as general-purpose microprocessors, digital signal processors (DSPs), application specific integrated circuits (ASICs), various types of signal conditioning circuitry, including analog-to-digital converters, digital-to-analog converters, input/output buffers, etc., such as a main processor 72, shown for illustrative purposes.

The present invention includes steps which, in various embodiments, may be carried out by elements of the main processor 72 executing sequences of instructions. The instructions may be stored in memory 73 as program code, often in the form of microcode, and data that enables the operation of the mobile terminal electronic equipment through the processor or processors so that the mobile terminal can operate within the wireless communication network. The memory 73 may include one or more physical memory devices, which may include volatile storage devices, non-volatile storage devices, or both. For example, the memory 73 may include both random access memory (RAM), read-only memory (ROM), various forms of programmable and/or erasable (ROM) (e.g., PROM, EPOM, EEPROM, etc.), flash memory, or any combination of such devices. Software instructions or data may be loaded into the mobile terminal electronic equipment from another device, such as a remote computer system, over a wireless connection.

The main processor 72 and memory 73 control the overall operation of the mobile terminal electronic equipment and are together referred to herein as a controller, which may be embodied in the control logic block 68, main processor 70, memory, or any combination thereof. The controller is operable to control the operating mode of the mobile terminal in response to unsolicited, over-the-air, push messages received through the radio block 66. In one embodiment of the present invention, the memory 70 stores predetermined settings for the audio characteristics of the speaker 16 based on the operating mode of the mobile terminal electronic equipment, although any recall method known in the art may be used such as a look-up table or hardware settings. Code signals received at the radio block 66 via the antenna 70 are processed by the mobile terminal's logic circuits and an audio signal is routed to the audio interface block 69. Based on the predetermined settings in memory 73, the audio gain circuit signals the speaker amplifier to amplify the received audio signal by a predetermined level under instructions from the controller and sends the audio signal to the speaker 16. According to the present invention, the capability of the controller to receive a signal and control the positioning of a mechanical element (described below) as a function of the signal also resides in memory 73.

To facilitate the description pertaining to FIG. 9B and also the other parts of the disclosure herein, it is henceforth assumed that aspects of the present invention are generally carried out through the execution of software instructions in the mobile terminal. It is envisioned that these instructions may be written in the Java language, or alternatively in C or C++. Note, however, that other languages may be substituted within the scope of the present invention. As is well-known, Java is an application designed specifically for network-connectable applications on consumer devices. The details of developing software in Java is well-known to those skilled in the relevant art and are not required for an understanding of the present invention. Accordingly, such details are not provided herein.

Certain embodiments of the present invention may be carried out by hard-wired circuitry rather than by executing software, or by a combination of hard-wired circuitry with software. Hence, it will be recognized that the present invention is not limited to any specific combination of hardware circuitry and software, nor to any particular source for software instructions. For example, the control logic block 54 and main processor 68 may be combined in one device as is known in the art.

FIGS. 10, 11, 12A and 12B illustrate respective images presented on a display 12 in accordance with examples of the present invention. In FIG. 10 the display 12 is set up, e.g., to provide an image pattern 80 according to the function 34 (FIG. 3B), for use as a mobile telephone. The display 12 in FIG. 10 may be a touch sensitive display so that upon pressing a virtual key shown on the display a signal is produced. Keys 14′ are virtual in that they are shown by the display and they are presented as a keypad like those used in a conventional touch tone telephone, mobile telephone, or the like, including numbers 0 through 9, an asterisk, and a pound sign. The display 12 in FIG. 10 also illustrates function buttons, such as, for example, an emergency button 81, a voice mail button 82, dial button 83, stop button 84, and volume increase and decrease buttons 85, 86. The display image 80 of FIG. 10 may be used on electronic equipment 20, for example, for that device to be operational as a mobile telephone. Touching the respective keys may present respective signals that are detected and used to enter a telephone number via the keys 14′, to dial the telephone call using the dial button 83, stopping the telephone call by using the key 84, checking voice mail by using the key 82, dialing an emergency telephone number using the key 81, and changing the volume of the sound emitted by the speaker 16, for example, using the keys 85, 86. The navigation device 13 in the electronic equipment may be used to point, e.g., by directing a cursor to overlie, a respective key of the keypad 14′ or one of the respective function buttons 81-86. When pointing to a given image, a selection signal may be provided to carry out the given function according to that which is pointed to, e.g., to increase or to decrease volume, to enter respective digits of a telephone number into a dialing string, etc.

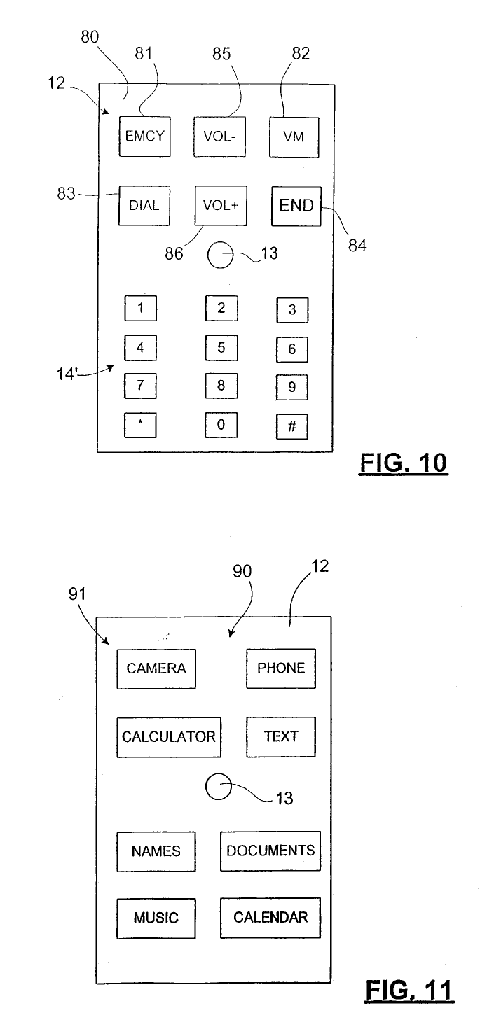

Fig. 11 illustrates another image pattern 90 for presentation on a display 12 of an electronic equipment 20, 20′, mobile telephone 10, 10′, etc. The image pattern 90 includes icons generally indicated at 91 to represent respective functions, as follows: camera, calculator, names, music, phone, text, documents and calendar. These may be functions that are useful in a mobile telephone, hand held computer, PDA, etc. The navigation device 13 may be used to point to any of the icons 91, and the selection signal may be provided, e.g., as was described above, to initiate the respective function. For example, pointing to the camera would initiate a camera or picture-taking function to be carried out by the electronic equipment 20, 20′, mobile phone 10, 10′. Pointing to the phone icon would set up operation of the electronic equipment to function as a mobile telephone, e.g., with a different image pattern than being shown on the display 12, for example, the image pattern 80 shown in FIG. 10. The calculator function may set up the electronic equipment to function as a calculator. The text icon may be selected to carry out text messaging. The names icon may be used to provide an address book. The documents icon may be selected to allow viewing of documents and/or creating documents; creating the documents may be carried out using a qwerty type keyboard that may be shown on the display 12. The music icon may be activated to cause music to be stored or played by the electronic equipment; and the calendar icon may be selected to display a calendar on the electronic equipment and to provide various calendar functions, including entering appointments, providing signal reminders, etc.

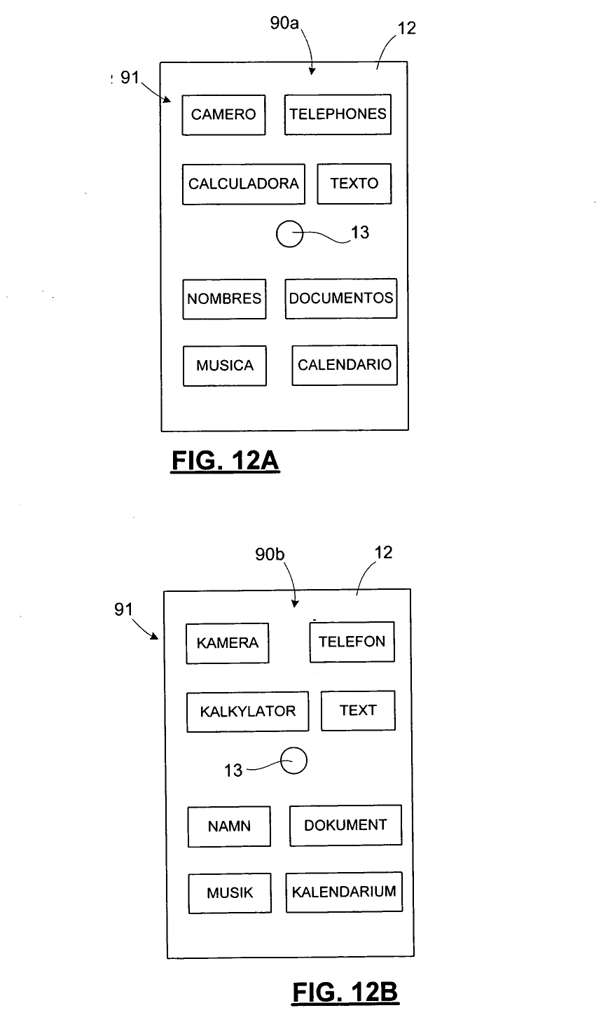

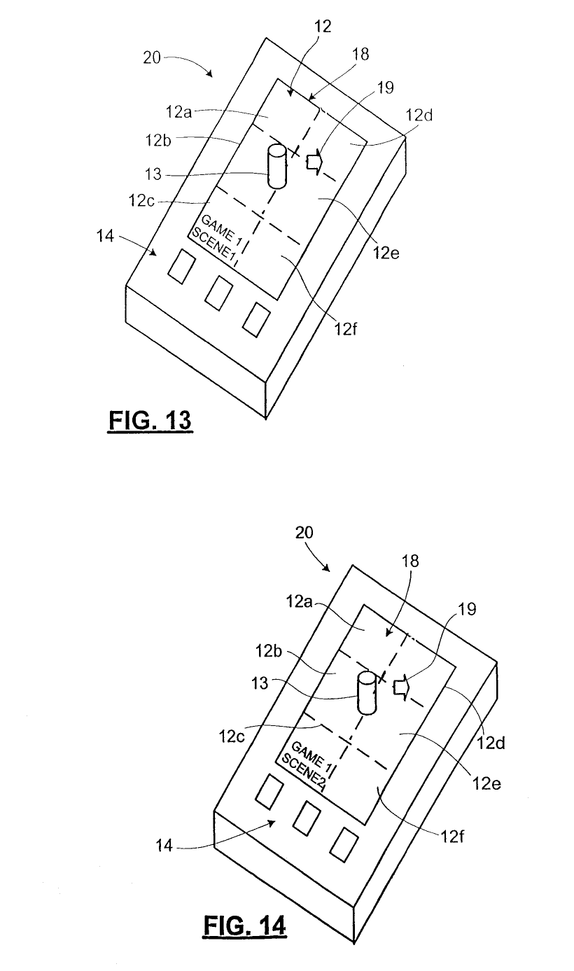

FIGS. 12A and 12B illustrate image patterns 90a, 90b that are the same as the image pattern 90 in FIG. 11, except that in FIG. 12A the image pattern 90a shows the icons in the Spanish language, and in FIG. 12B the image pattern 90b shows the icons in the Swedish language. The electronic equipment 10, 10′, 20, 20′ may include a list of languages to which a user may point using the navigation device 13 to set up the electronic equipment for use with a given language. One of the image patterns presented on the display 12 may include a list of languages; and the navigation device 13 may be used to point to a language. The language can be implemented by providing a selection signal while that language is pointed to; and thereafter the electronics 71 (FIG. 9a) may operate the electronic equipment to provide image patterns in the selected language.

FIGS. 13 and 14 illustrate electronic equipment 20 that is used to play a game. On the display 12 in FIG. 13 the image pattern presented is for a first game, the first scene of that game. The game may be played using the navigation device 13 and to the keys 14. The first scene of the game may be a relatively low level, easily played part of the game, and when that scene and part of the game are concluded satisfactorily, the screen may switch automatically or by user control (e.g., using the navigation device 13 to point to a selected area of the display 12 and providing a selection signal and/or operating one or more of the keys 14) to a second scene of the game, as is illustrated in FIG. 14. The navigation device may be used to point to respective icons or function areas, etc., of the screen 12, for example, any of areas 12a-12d. By pointing to a given segment and providing a selection signal the electronics 65 may cause a desired image pattern to be presented on the display. As the user completes each of the portions of the game represented by respective segments 12a-12f, the electronics 65 may switch the image pattern to that shown in FIG. 14 for the second scene or the user may operate the navigation device 13 and provide a selection signal to change the image pattern to the next scene, next game, etc.

It will be appreciated that the games may be portrayed in different respective languages, for example, as was described in an exemplary manner with respect to FIGS. 11, 12a and 12b. Other changes can be made to the display by pointing to respective icons and functions presented on the display 12 and providing an appropriate selection signal.

Turning to FIGS. 15-18, schematic illustrations of the front of respective electronic equipment are illustrated at 20a, 20b, 20c, and 20d. The electronic equipment 20a-20d may be the same or similar to the electronic equipment 20, 20′ described above and/or the same as or similar to the mobile telephones 10, 10′ described above.

In the electronic equipment 20a (FIG. 15) the navigation device 13a is a rocker switch 100 with a number of rocker segments 101-104, and a selector button 105. The rocker switch and selector button may be of conventional type, e.g., as are used in conventional mobile telephones, hand held computers, PDAs, etc., and may be operated in conventional manner as they are in such devices. By pressing a respective rocker switch segment 101-104 a signal is provided to electronics 65, for example, to cause a cursor 21 to point to a given location on the display 12. A selection signal may be provided by pressing the selector button 105.

In the electronic equipment 20b (FIG. 16) the navigation device 13b is a track ball 110. The track ball may be rotated in the conventional manner of a track ball type device, and it may be pressed to effect production of a selection signal. As is well known, a track ball 110 is retained in a track ball support 111 to provide, on the one hand, for rotation of the track ball and also to provide for slight linear movement of the track ball, for example, in a vertical direction, e.g., into or out of the plane of the paper illustrating FIG. 16, to provide a selection signal function. A transducer detects the rotational movement of the track ball, as is conventional, and provides a signal indicating motion and/or position, thus, positions of a cursor 100 or the like.

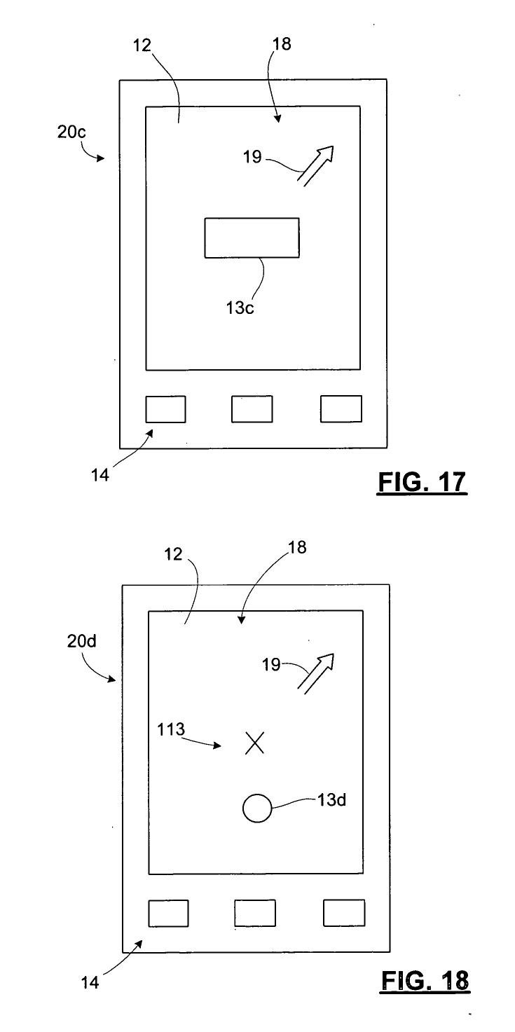

In FIG. 17 the electronic equipment 20c has a navigation device 13c in the form of a touch pad, such as, for example, a conventional touch pad type of device for moving a cursor as is used in laptop computers and in other systems to move a cursor, etc. The touch pad also may be tapped to provide a selection signal.

The electronic equipment 20d (FIG. 18) has a navigation device 13d that is in the viewable area of the display 12, but is somewhat offset from the center 113 of the display 12. Thus, it will be appreciated that in the several embodiments illustrated and described herein, the navigation device is within the viewable area of the display, but it need not be at or near the center of the display.

1. Electronic equipment, comprising a display and a navigation device, the display and navigation device merged such that the navigation device physically is within viewable area of the display.

2. The electronic equipment of claim 1, comprising a mobile phone, including transmitter, receiver, and logic and control circuitry.

3. The electronic equipment of claim 1, comprising a hand held electronic device.

4. The electronic equipment of claim 1, the display having a viewable area, and the navigation device is within that viewable area.

5. The electronic equipment of claim 4, the navigation device comprising a stick-like device.

6. The electronic equipment of claim 1, the display comprising a touch sensitive display.

7. The electronic equipment of claim 1, further comprising control and logic circuitry responsive to operation of the navigation device to operate the display to show an indication that an area of the display to which the navigation device is pointing, and a selector providing input to the control and logic circuitry to carry out a function with regard to the area to which the navigation device is pointing.

8. The electronic equipment of claim 4, comprising adhesive attaching the stick-like device relative to the display.

9. The electronic equipment of claim 1, an opening through which the navigation device is mounted relative to the display.

10. The electronic equipment of claim 1, said opening being through the display and the navigation device extending through the opening.

11. The electronic equipment of claim 4, comprising a support holding the navigation device over the front of the display.

12. The electronic equipment of claim 4, comprising a transducer responsive to positional orientation of the navigation device to provide signals representing such orientation.

13. The electronic equipment of claim 12, the display comprising a touch sensitive display, and the transducer comprising a portion of the touch sensitive display.

14. The electronic equipment of claim 4, the display comprising a touch sensitive display, and the navigation device comprising a virtual display shown by the touch sensitive display.

15. A method of using electronic equipment, comprising operating a navigation device located within viewable area of a display of the electronic equipment to point to a selection that is shown on the display.

16. The method of claim 15, comprising acting on the selection.

17. The method of claim 15, comprising changing the image shown on the display and coordinating operating of the navigation device with respect the shown image.

18. The method of claim 16, said acting comprising pressing a key.

19. The method of claim 16, said acting comprising pressing the navigation device.

20. The method of claim 15, said operating comprising moving a joy stick that is mounted on or through the display.

21. The method of claim 15, said operating comprising moving a trackball that is mounted on or through the display.

22. The method of claim 15, said operating comprising operating a touch pad.

23. The method of claim 15, said operating comprising pressing a touch sensitive display.

24. The method of claim 16, said operating a navigation device and acting on the selection comprises changing the functions of the electronic equipment in coordination with the image shown on the display.

25. The method of claim 16, said operating a navigation device and acting on the selection comprises changing the language of functions shown on the display.
